(19) United States
(12) Patent Application Publication
(10) Pub. No.: US 2007/0228681 A1
(43) Pub. Date: Oct. 4, 2007

(54) File Cabinet Caddy

(76) Inventor: David A. Schenker, Cedarburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/278,183

(22) Filed: Mar. 31, 2006

(51) Int. Cl. B62B 5/00

(52) U.S. Cl. 280/79.11

(57) ABSTRACT

A file cabinet dolly is provided that includes a rectangular support frame consisting of four L-shaped corner members and interconnecting side rails. Each corner member receives a corner support having a contact plate. The top surface of the contact plate is coplanar with the top surface of the side rails when the side rails are secured between the corner members to define a support plane for the file cabinet. Each of the fasteners used to secure the side rails to the corner members is recessed below the support plane such that only the support plane contacts the bottom edge surface of the file cabinet, including in the corners of the file cabinet.

### BACKGROUND OF THE INVENTION

The present invention relates to a dolly for use in supporting and moving a file cabinet. More specifically, the present invention relates to a file cabinet dolly that includes an adjustable frame having a plurality of side rails and corner supports to provide stable support for the comers of the file cabinet.

File cabinets are well known, useful devices for storing and organizing material, particularly various types of paper files. File cabinets typically come in different styles and have a generally flat bottom and two or more drawers supported in a vertical alignment. Although file cabinets are formed from a typically lightweight, durable metallic material, once the cabinet has been filled with paper files, the file cabinet becomes difficult to move unless the files are removed, which is both inconvenient and time-consuming.

Typically, file cabinets include a generally planar bottom edge surface that supports the cabinet on a floor of a building. Since it is desirable for the cabinet to be stable, the bottom edge surface of the file cabinet extends along a single plane to prevent the cabinet from tipping during usage.

Presently, various devices are known to transport articles, such as file cabinets. These devices, referred to as dollies, include joined side frame members that are adjustable in length such that the dolly can be configured to correspond to the size of the particular file cabinet. One example of a file cabinet dolly is shown in U.S. Pat. No. 6,203,031 to Leverington. This file cabinet dolly is adjustable in size to accommodate various different size file cabinets. However, the device taught in the '031 patent, like many other devices available, include fasteners having heads that protrude upward from the top surface of the support frame members. Thus, the frame members do not present a continuous, generally planar support surface to support the cabinet. Instead, the side frames have multiple levels which allow the file cabinet, and particularly the corners, to become unstable during transportation.

Therefore, a need exists for a file cabinet dolly that can be adjusted to accommodate cabinets of different sizes yet is simple in design, economical to construct, easy to assemble and which presents a stable support surface for the cabinet.

### SUMMARY OF THE INVENTION

The present invention relates to a file cabinet dolly for supporting a file cabinet such that the file cabinet can be easily transported. The file cabinet dolly includes an adjustable support frame that allows the dolly to be utilized with file cabinets having various sizes.

The support frame of the file cabinet dolly includes four L-shaped corner members each preferably formed from a metallic material. Each corner member includes a pair of support legs that extend perpendicular to each other and define a generally planar top surface. Each support leg includes a series of spaced adjustment openings that allow the sides of the support frame to be selectively adjusted. Each corner member receives a pair of side rails such that the combination of the side rails and corner members define the rectangular support frame. Each side rail includes a generally planar top surface and a generally planar bottom surface separated by the thickness of the side rail. The side rails include an access opening positioned near the end of the side rail such that the side rail can be secured to the support leg of the corner member by a fastener that passes through the aligned access opening in the side rail and one of the adjustment openings formed in the support legs. Preferably, the access opening is tapered and decreases in diameter from the top surface of the side rail to the bottom surface of the side rail. The tapered access opening allows the expanded head of the fastener to be recessed below the top surface of the side rail.

Each of the corner members receives a corner support positioned at the 90° intersection between the pair of support legs. Each corner support includes a generally planar contact plate having a generally planar top surface. The top surface of the contact plate is positioned above the top surface of the corner member. The corner support is attached to the corner member by a series of connectors each recessed from the top surface of the corner support. The corner support includes a pair of extending flanges that each extend perpendicular to the top surface of the corner support.

When the corner support is attached to the corner member, the top surface of the corner support is generally planar with the top surface of each of the side rails. The combination of the top surface of the corner support and the top surface of the side rails defines a support plane for the entire support frame of the file cabinet dolly. Each of the fasteners that secures the side rail to the corner member is recessed below the support plane, as are the series of connectors used to attach the corner support to the corner member. Thus, a substantial portion of the bottom edge surface of the file cabinet, including each of the comers, is supported along the support plane defined by the top surface of the side rails and the top surface of the corner supports.

### BRIEF DESCRIPTION OF THE DRAWINGS

The drawings illustrate the best mode presently contemplated of carrying out the invention. In the drawings:

FIG. 1 illustrates a perspective view of the file cabinet dolly supporting a file cabinet shown in phantom;

FIG. 2 is an exploded view of one of the corners of the file cabinet dolly;

FIG. 3 is a section view taken along line 3-3 of FIG. 1; and

FIG. 4 is a section view similar to FIG. 3 showing the selective positioning of one of the side rails.

### DETAILED DESCRIPTION OF THE INVENTION

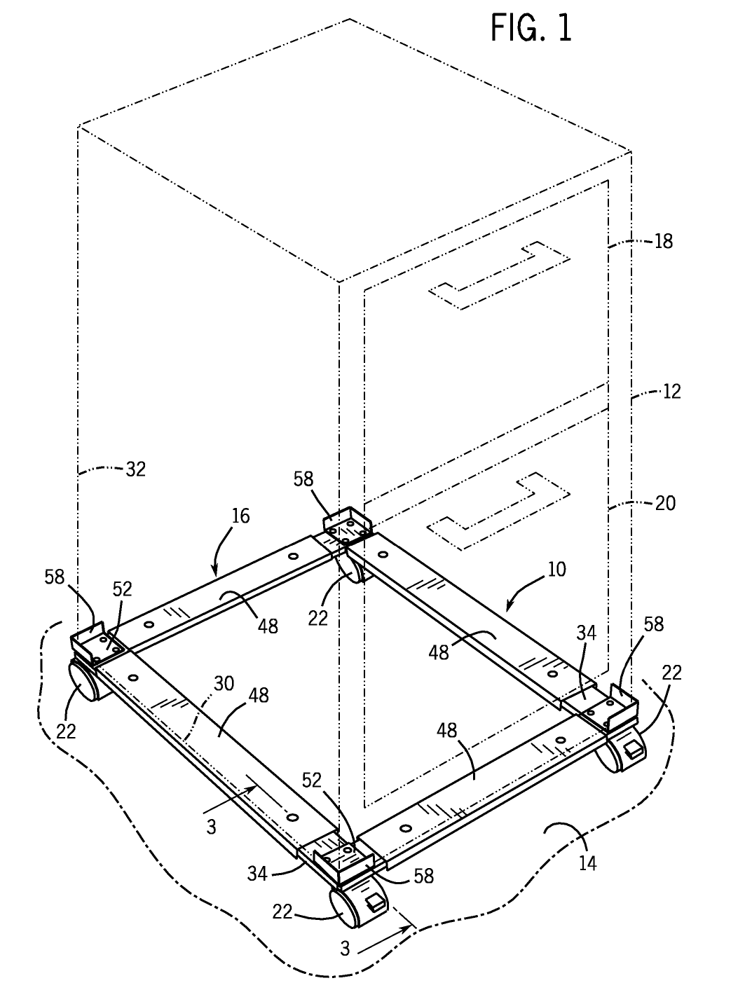

FIG. 1 illustrates a dolly 10 constructed in accordance with the present invention. As shown in FIG. 1, the dolly 10 supports a file cabinet 12 to permit the file cabinet 12 to be moved along a support surface, such as the floor 14. The dolly 10 generally includes a rectangular support frame 16 that is adjustable to permit accommodation of file cabinets 12 having various widths and depths. In the embodiment of the invention shown in FIG. 1, the file cabinet 12 includes a pair of drawers 18, 20, although other size file cabinets are contemplated as being supported by the dolly 10.

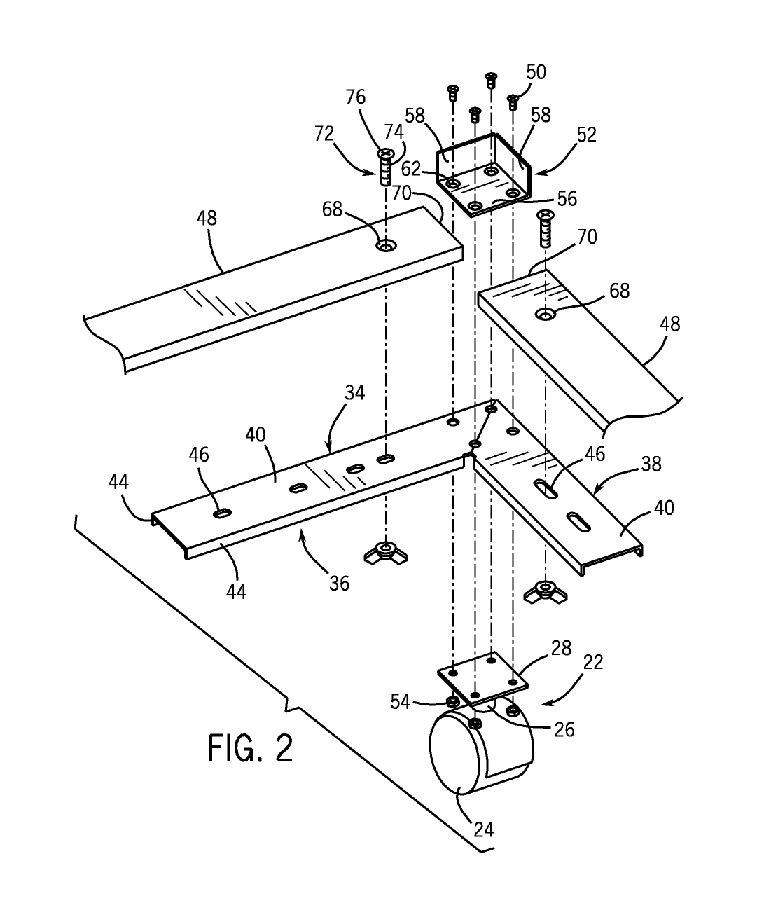

The support frame 16 of the file cabinet dolly 10 is supported by a series of casters 22 that are each located in the corners of the generally rectangular support frame 16. As best illustrated in FIG. 2, each of the casters 22 includes a rotating caster wheel 24 supported on a vertical shaft 26 secured to an attachment plate 28. The caster wheels 24 each rotatably mounted to the vertical shaft 26 to permit rolling movement of the caster 22 along a surface.

Referring back to FIG. 1, the file cabinet 12 includes a generally planar bottom edge surface 30 that is defined by four corners 32. The bottom edge surface 30 provides a generally planar support edge for the file cabinet 12 such that the file cabinet 12 is stable when supported on a planar support surface, such as the floor. However, when the file cabinet 12 is supported on a dolly, the file cabinet 12 must be supported along a substantial portion of the bottom edge surface 30 to prevent the file cabinet 12 from tipping during movement and use. Prior art file cabinet support, such as shown in U.S. Pat. No. 6,203,031, provide uneven support for the bottom edge surface 30 and allow the cabinet to shift during usage and transport.

Referring back to FIG. 2, the support frame of the file cabinet dolly includes four L-shaped corner members 34 that are formed from stamped metal and include a pair of support legs 36, 38. The support legs 36, 38 are preferably welded together and extend from each other at a generally 90° angle to define the corner member 34.

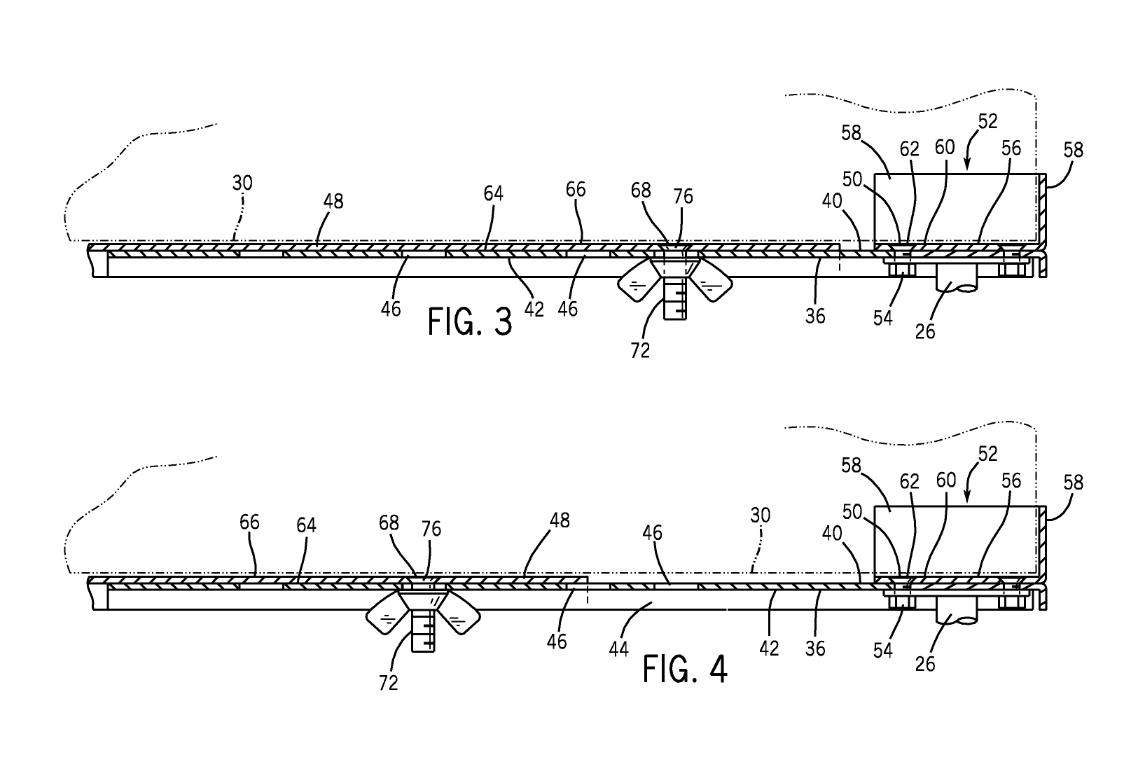

Each of the support legs 36, 38 includes a generally planar top surface 40 and a generally planar bottom surface 42 (FIG. 3). Each of the support legs 36, 38 includes a pair of depending side flanges 44 such that each of the support legs 36, 38 has a generally U-shaped cross-section.

Each of the support legs 36, 38 includes a series of spaced adjustment openings 46 that allows the size of the file cabinet dolly support frame to be adjusted to compensate for different size file cabinets in a manner to be discussed in greater detail below.

The corner member 34 receives a series of connectors 50 that pass through a corner support 52, the corner member 34 and the attachment plate 28 of the caster 22. Each of the connectors 50 receives a nut 54 to secure both the caster 22 and the corner support 52 to the corner member 34.

The corner support 52 includes a generally planar contact plate 56 and a pair of upstanding flanges 58 that extend perpendicular to the generally planar top surface 60, as best shown in FIG. 3. In the preferred embodiment of the invention, the corner support 52 is formed from a metallic material and includes four countersunk attachment openings 62. Each of the attachment openings 62 receives one of the connectors 50 such that the expanded head of each connector 50 is flush with the top surface 60 when the connector is positioned as shown in FIG. 3.

As can be seen in FIG. 3, the top surface 60 of the corner support 52 extends above the top surface 40 of the support leg 36 by the thickness of the contact plate 56.

As illustrated in FIG. 2, each of the corner members 34 receives a pair of side rails 48. Each of the side rails 48 has a width slightly larger than the width of the corresponding support leg 36, 38 such that the side rail 48 can be positioned in contact with the top surface 40 of the support leg. Specifically, the bottom surface 64 of the side rail 48 contacts the top surface 40 of the support leg 36 as illustrated in FIG. 3. When the side rail 48 is supported as shown in FIG. 3, the generally planar top surface 66 of the side rail 48 extends above the top surface 40 of the support leg by the thickness of the side rail 48. In the preferred embodiment of the invention, the thickness of the side rail 48 generally corresponds to the thickness of the contact plate 56 of the corner support 52 such that the top surface 66 of the side rail 48 is generally coplanar with the top surface 60 of the contact plate 56. Thus, when the dolly is used to support a file cabinet, the bottom edge surface 30 of the file cabinet is securely supported along a support plane that is defined by the top surface 66 of the side rail 48 and the top surface 60 of the corner support 52. Although only one of the corners of the support frame is shown in FIG. 3, it should be understood that each corner of the support frame presents the same support plane to support the bottom edge surface 30 of the file cabinet.

As illustrated in FIGS. 2 and 4, each of the side frames 48 includes an access opening 68 positioned near an end 70 of the respective side rail 48. Each of the access openings 68 receives a primary fastener 72 having a threaded shaft 74 and expanded head 76. The fastener 72 passes through both the access opening 68 and one of the adjustment openings 46 formed in one of the legs of the corner member 34. As can be understood in FIGS. 3 and 4, the position of the side rail 48 can be adjusted along the length of the respective support leg 36, 38 to adjust the size of the support frame.

Referring now to FIG. 4, the access opening 68 is tapered and has a decreasing diameter from the top surface 66 to the bottom surface 64 of the side rail 48. Thus, when the fastener 72 is received by the side rail and the corner member, as shown in FIG. 4, the expanded head 76 is recessed from the top surface 66. In this manner, the expanded head 76 does not protrude above the support plane and into contact with the bottom edge surface 30 of the file cabinet.

Referring back to FIG. 1, when the support frame 16 is properly sized, a majority of the bottom edge surface 30 of the file cabinet 12 is supported by the top surface of each side rail 48 while the respective corners 32 of the file cabinet are supported by the top surface of the contact plate of each corner support 52. The extending flanges 58 formed on each of the corner supports 52 provides additional stability for the file cabinet 12 to prevent the file cabinet 12 from sliding off of the support frame 16, such as if the caster wheels 12 become stuck during transport of the file cabinet 12.

As can be understood by the above description and the drawing of FIG. 1, a substantial portion of the bottom edge surface 30 of the file cabinet, including each of the comers, is supported by a support plane defined by the dolly 10. Specifically, the top surfaces of each of the side rails 48 and corner supports 52 support the file cabinet along each of its edges as well as in each corner. The fasteners used to selectively adjust the size of the support frame are each recessed below the top surface of the side rails such that the fasteners do not contact the bottom edge surface of the file cabinet. In this manner, the file cabinet 12 is securely supported along the support plane without interference from the protruding fasteners, as was the case in prior art file cabinet dollies.

Although the corner member side rails are described in the preferred embodiment of the invention as being formed from metallic material, it should be understood that these components could also be replaced with plastic components while operating within the scope of the present invention.

I claim:

1. A dolly for supporting a file cabinet, comprising:
a plurality of L-shaped corner members each having a pair of support legs extending perpendicular to each other and having coplanar top surfaces;
a plurality of side rails each supported between the support legs of two of the L-shaped corner members such that the plurality of side rails and the plurality of L-shaped corner members define a rectangular support frame, each side rail having a planar top surface and a planar bottom surface, wherein the bottom surface of each of the side rails is supported on the top surface of one of the L-shaped corner members;
a fastener for securing each of the side rails to one of the support legs of the corner members;
a plurality of corner supports, each corner support having a planar contact plate secured to one of the corner members, wherein a top surface of the contact plate is generally coplanar with the top surface of the two side rails when the side rails are supported by the corner section; and
a plurality of casters each mounted to one of the L-shaped corner members.

2. The dolly of claim 1 wherein each of the fasteners includes an expanded head and a shaft, wherein each fastener extends through an access opening in the side rail and an aligned adjustment opening in one of the legs of the corner member, wherein the expanded head is positioned below the top surface of the side rails when the side rail is secured to the corner member.

3. The dolly of claim 1 wherein each of the corner supports includes a pair of flanges extending perpendicular to the top surface of the contact plate.

4. The dolly of claim 2 wherein each leg of the corner member includes a plurality of spaced adjustment openings such that the side rails can be selectively positioned along the legs of the corner member to adjust the size of the rectangular support frame.

5. The dolly of claim 1 wherein each of the corner supports are removably secured to the corner members.

6. The dolly of claim 1 wherein the top surface of each of the corner supports and the top surface of each of the plurality of side rails are generally coplanar to define a support plane for the file cabinet.

7. The dolly of claim 2 wherein the diameter of each of the access openings in the side rails decreases from the top surface of the side rail to the bottom surface of the side rail.

8. The dolly of claim 3 wherein the top surface of the contact plate of the corner support is positioned above the top surface of the corner member.

9. The dolly of claim 1 wherein the top surface of each of the side rails is positioned above the top surface of the support leg of the corner member.

10. The dolly of claim 6 wherein each of the fasteners are positioned below the support plane.

11. A dolly for supporting a file cabinet, comprising:
a plurality of L-shaped corner members each having a pair of support legs extending perpendicular to each other and having coplanar top surfaces;
a plurality of side rails each supported between the support legs of two of the L-shaped corner members such that the plurality of side rails and the plurality of L-shaped corner members define a rectangular support frame, each side rail having a planar top surface and a planar bottom surface, wherein the bottom surface of each of the side rails is supported on the top surface of one of the L-shaped corner members;
a plurality of corner supports, each corner support having a planar contact plate secured to one of the corner members, wherein a top surface of the contact plate is generally coplanar with the top surface of the two side rails when the side rails are supported by the corner section to define a support plane for the file cabinet;
a plurality of fasteners for securing each of the side rails to the support leg of one of the corner members, wherein each of the fasteners are positioned below the support plane; and
a plurality of casters each mounted to one of the L-shaped corner members.

12. The dolly of claim 11 wherein each of the fasteners includes an expanded head and a shaft, wherein each fastener extends through an access opening in the side rail and an aligned adjustment opening in one of the legs of the corner member, wherein the expanded head is positioned below the top surface of the side rails when the side rail is secured to the corner member.

13. The dolly of claim 11 wherein each of the corner supports includes a pair of flanges extending perpendicular to the top surface of the contact plate.

14. The dolly of claim 13 wherein each leg of the corner member includes a plurality of spaced adjustment openings such that the side rails can be selectively positioned along the legs of the corner member to adjust the size of the rectangular support frame.

15. The dolly of claim 11 wherein each of the corner supports are removably secured to the corner members.

16. The dolly of claim 12 wherein the diameter of each of the access openings in the side rails decreases from the top surface of the side rail to the bottom surface of the side rail.
